(19) United States
(12) Patent Application Publication
(10) Pub. No.: US 2015/0310991 A1
(43) Pub. Date: Oct. 29, 2015

(54) MULTI-LAYERED CERAMIC CAPACITORS

(71) Applicant: Apple Inc., Cupertino, CA (US)

(72) Inventors: Gang NING, Santa Clara, CA (US); Shawn X. ARNOLD, Santa Cruz, CA (US)

(73) Assignee: Apple Inc., Cupertino, CA (US)

(21) Appl. No.: 14/265,147

(22) Filed: Apr. 29, 2014

(51) Int. Cl. H01G 4/30; H01G 4/12; H01G 4/012

(52) U.S. Cl. CPC H01G 4/30; H01G 4/012; H01G 4/12

(57) ABSTRACT

This application relates to multi-layered ceramic capacitors (MLCC) that can be surface mounted, include multiple terminals, and handle multiple voltages. The MLCC can include electrode and dielectric layers that are stacked in parallel to a printed circuit board (PCB) on which the MLCC can be attached. A set of primary conductive pads can be formed on the bottom of the MLCC in order to create a conductive interface between the PCB and the MLCC. Secondary conductive pads are formed on the side of the MLCC, and can extend perpendicular to the PCB. The secondary conductive pads are created by stacking internal electrode plates together and connecting them electrically and mechanically to each another. This arrangement provides for multiple voltages and electrical connections at the MLCC while reducing reverse piezoelectric and/or electro-striction noise.

### FIELD

The described embodiments relate generally to multi-layered ceramic capacitors. More particularly, the present embodiments relate to surface mounted, multi-layered ceramic capacitors having multiple terminals.

### BACKGROUND

Recent advances in electronics manufacturing have resulted in remarkable electrical components that operate far superior to many electrical components manufactured in the past. These advanced electrical components have overcome many previous limitations related to performance and functionality. However, many problems of the past still exist in modern electrical components despite many of the advancements in device manufacturing. For instance, circuit noise is a common issue for a variety of circuit designs. In particular, noise created by the reverse piezoelectric and/or electro-striction effect is still a prevalent problem in circuits relying on certain types of capacitors. This type of noise originates, in part, from alternating current traveling through the dielectric of a capacitor and causing a printed circuit board dielectric to vibrate at an audible frequency. As a result, the capacitor transfers these vibrations to the circuit board thereby interfering with other functions of the circuit board.

### SUMMARY

This paper describes various embodiments that relate to multi-layered ceramic capacitors. In some embodiments, an apparatus is set forth having a dielectric layer and an active region. The active region can include a conductive plate that has a tab extending from an adjacent portion of the conductive plate and abuts the dielectric layer. The apparatus can further include a secondary conductive layer including a secondary electrode that contacts the tab of the conductive plate. Additionally, the apparatus can include a primary conductive layer having a primary electrode that contacts the printed circuit board (PCB) and the secondary electrode such that a conductive pathway is created between the primary conductive layer and conductive plate through the secondary conductive electrode.

In some embodiments, a capacitor is set forth as having a dielectric region that includes a first dielectric plate and an active region having a conductive plate and a second dielectric plate. The conductive plate can include a tab that extends outward from an adjacent portion of the conductive plate. The capacitor can also include a secondary conductive layer that includes a secondary electrode that abuts the tab. Additionally, the capacitor can include a primary conductive layer that includes a primary electrode that abuts the secondary electrode in a z-direction.

Furthermore, in some embodiments, a method for constructing an electrical component is set forth. The method can include a step of placing a dielectric plate against a first conductive plate, wherein the first conductive plate includes a first tab that extends from an adjacent portion of the first conductive plate and abuts the dielectric layer. The method can further include a step of placing a secondary conductive layer against the first conductive plate, wherein the secondary conductive layer includes a secondary electrode that is configured to contact the tab of the conductive plate. Moreover, the method can include placing a primary conductive layer against the secondary conductive layer, wherein the primary conductive layer includes a primary electrode that is configured to contact the secondary electrode such that a conductive pathway is created between the primary electrode and the first conductive plate through the secondary electrode.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a perspective view of a multi-layer ceramic capacitor (MLCC) according to some embodiments set forth herein;

FIG. 2 illustrates an exploded view of the MLCC FIG. 1 according to some embodiments set forth herein;

FIG. 3 illustrates an exploded view of an embodiment of the MLCC according to some embodiments set forth herein;

FIG. 4 illustrates a side view of the exploded view of the MLCC of FIG. 2 according to some embodiments set forth herein;

FIG. 5A-5C illustrate various perspective views of the embodiment of the MLCC according to some embodiments set forth herein;

FIG. 6 illustrates a perspective view of the MLCC according to some embodiments set forth herein;

FIG. 7A-7C illustrate various perspective views of the MLCC of FIG. 6 according to some embodiments set forth herein;

FIGS. 8A-8D illustrate embodiments having different means for attaching a primary conductive pad of the MLCC and a printed circuit board (PCB) according to some embodiments set forth herein;

FIG. 9 illustrates an embodiment of the MLCC having two connections to the PCB;

FIG. 10 illustrates an embodiment of the MLCC having eight secondary conductive pads;

FIG. 11 illustrates an exploded view of the MLCC of FIG. 10 according to some embodiments set forth herein;

FIG. 12 illustrates a perspective view of the MLCC according to an embodiment discussed herein; and

FIG. 13 illustrates a method of creating the MLCC according to some embodiments discussed herein.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments discussed herein relate to a multi-layer ceramic capacitor (MLCC) that can be surface mounted, include multiple terminals, and handle multiple voltages. An MLCC is a combination of capacitors stacked together using multiple dielectric layers and electrode layers. When an MLCC receives alternating current, vibrations can occur creating what is called the reverse piezoelectric and/or electro-striction effect, which can generate audible noise from a circuit through exiting the PCB. In order to mitigate this noise, a surface mounted MLCC is provided herein. The MLCC can include electrode and dielectric layers that are stacked in parallel on the printed circuit board (PCB) to which the MLCC can be attached. Primary conductive pads are formed on the bottom of the MLCC in order to create a conductive interface between the PCB and the MLCC. The primary conductive pads can be arranged in parallel or perpendicular to each other, or a combination thereof. Secondary conductive pads are formed on the side of the MLCC, and can extend perpendicular to the PCB. The secondary conductive pads are created by stacking internal electrode plates together and connecting them electrically and mechanically to one another. The internal electrode plates can include multiple tabs at the edges of the electrode plates, or at other regions of the electrode plates where an electrode is desired. The connection of the tabs in a stack essentially forms secondary conductive pads. The arrangement of the tabs determines the size of the secondary conductive pads, and can be configured, along with the design of the primary conductive pads, to optimize the size and shape of a solder fillet that is used to connect the MLCC to a PCB.

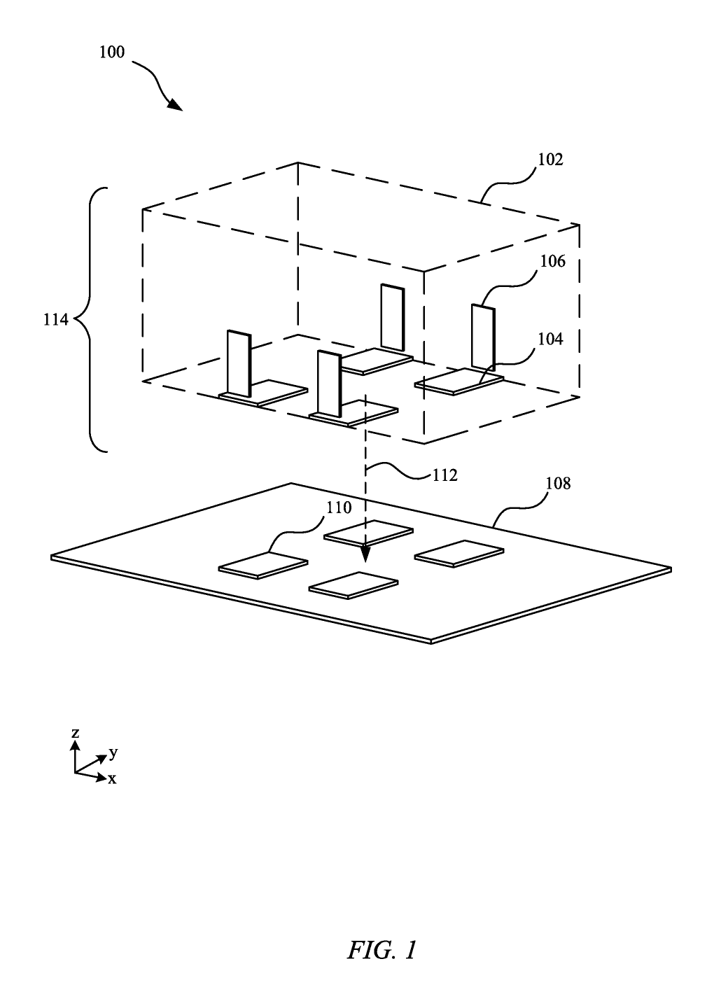

These and other embodiments are discussed below with reference to FIGS. 1-13; however, those skilled in the art will readily appreciate that the detailed description given herein with respect to these figures is for explanatory purposes only and should not be construed as limiting.

FIG. 1 illustrates a perspective view 100 of the MLCC 114 according to some embodiments set forth herein. In particular, FIG. 1 illustrates an embodiment of the MLCC 114 where the primary conductive pads 104 are formed on a surface of the MLCC 114 parallel to the printed circuit board (PCB) 108 and extend parallel in the y-direction. The secondary conductive pads 106 extend substantially in the z-direction and x-direction, perpendicular to both the PCB 108 and the primary conductive pads 104. In some embodiments, the MLCC 114 includes a dielectric region 102 having a dielectric plate and an active region having a conductive plate and a second dielectric plate. The dielectric region 102 can be formed from stacks of dielectric layers oriented parallel to the PCB 108. The dielectric layers interface with multiple electrode layers to create the active region of the MLCC 114 as discussed further herein.

The MLCC 114 is configured to contact the PCB 108 in the direction 112 so that the primary conductive pads 104 abut the PCB contacts 110. During assembly, solder can be deposited to the PCB 108, which contacts the primary conductive pads 104 and secondary conductive pads 106. By controlling the shape and size of both the primary and secondary conductive pads, the solder fillet shape and size can be minimized. However, in some embodiments, solder balls, or bumps, can be used between the primary conductive pads 104 and the PCB contacts 110 in order to provide a conductive path while also limiting the amount of solder used between the primary conductive pads 104 and the PCB contacts 110. In this way, reverse piezoelectric and/or electro-strictive noise is mitigated because smaller solder fillet has been demonstrated to be able to dampen the vibration of the PCB. By limiting or removing solder from the MLCC 114 design, less solder is available to transfer piezoelectric vibrations to the PCB 108. Moreover, by creating an MLCC 114 having multiple terminals (e.g., two, three, four, or more) that can handle multiple voltages, the deformations of the ceramic material inside a capacitor may cancel out each other, thus showing negligible or small net deformation and further reducing acoustic noise.

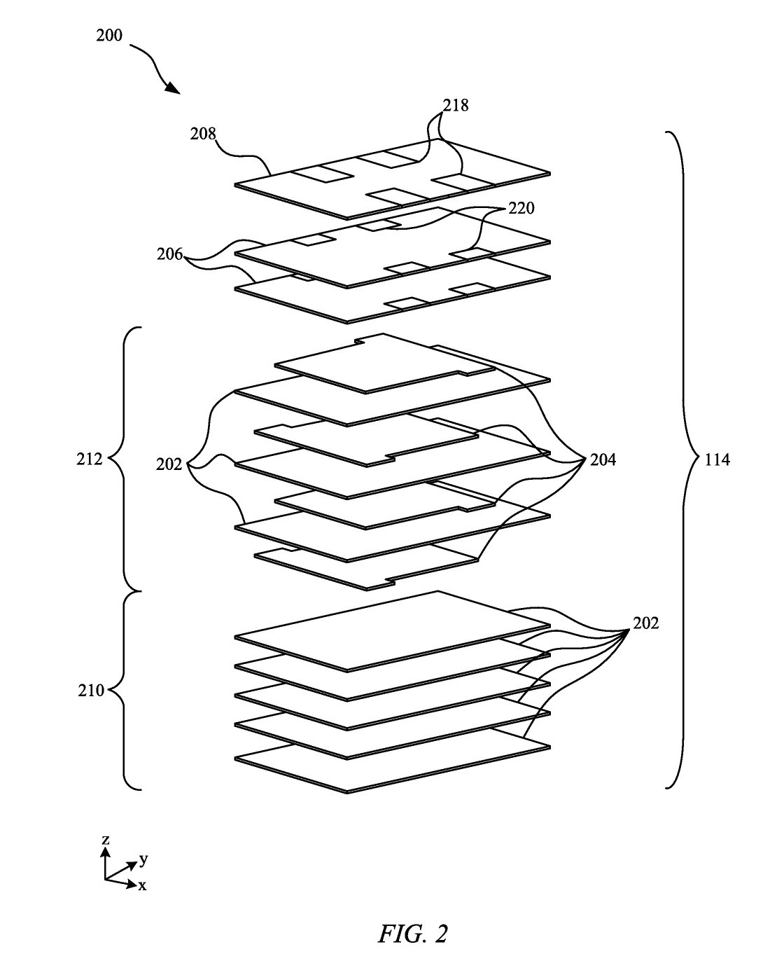

FIG. 2 illustrates an exploded view 200 of the MLCC 114 of FIG. 1. Specifically, FIG. 2 sets forth the arrangement of the various layers of the MLCC 114 for a build process of the MLCC 114 according to some embodiments. During a build process of the MLCC 114, the dielectric layers 202 are stacked to create a base 210 for the MLCC 114. The base 210 can be the top of the MLCC 114 relative to the PCB 108 once the MLCC 114 is assembled and attached to the PCB 108. Also, the base 210 can be created to be thicker or thinner by adding more or less dielectric layers 202. For instance, in some embodiments the number of dielectric layers 202 can depend on the number of primary electrodes 218 on the primary conductive layer 208, the desired capacitance for the primary electrodes 218, the desired dampening properties for the MLCC 114 and/or the base 210, or any other suitable property of the MLCC 114.

The conductive layers 204, internal to the MLCC 114, include tabs that project from conductive layers 204 in the x-direction and/or y-direction such that the tabs can ultimately be connected to the secondary conductive pads 106 after assembly of the MLCC 114. The orientation of the tabs provides connections for multiple voltages at the MLCC 114. For example, FIG. 2 illustrates conductive layers 204 having tabs that alternate orientation for each layer of the conductive layers 204. In this way, the tabs that overlap in the z-direction will share voltages and connect to the same primary electrodes 218 and secondary electrodes 220.

The region of 206, which is the bottom cover layer upon placement on a PCB, is characterized by a stack-up of multiple dielectric layer and secondary electrodes 220. The secondary electrodes 220, which can also be optional, helps to create a portion of the secondary conductive pads 106 of FIG. 1, which connects the primary conductive pads 104 and internal electrode 204 within an MLCC. State of the art coating processes are not necessary for the secondary electrodes 224 to bridge the primary conductive pads 104 and internal electrode 204 within an MLCC 114. Moreover, the thickness of the region of 206 can be adjusted by the number of dielectric layers. A thicker region of 206 leads to longer secondary conductive pads 106 along the z-direction. This also applies to the primary conductive pads 104, which are made up of the primary electrodes 218 of the primary conductive layer 208. By including one or more primary conductive layers 208, the dimensions of the primary conductive pads 104 can be modified. For example, in some embodiments the primary electrodes 218 and secondary electrodes 220 can all be of equal dimensions, varying dimensions, square, rectangular, triangular, curved, elliptical, or any suitable combination thereof. Moreover, stacks of primary conductive layer 208 can be implemented in some embodiments of MLCC 114. The number of layers of the primary conductive layer 208 and secondary conductive layer 206 can affect the shape and size of the solder fillet that connects the MLCC 114 to the PCB 108, while also maintaining a high capacitance for the MLCC 114, and the minimum shear force and jump test requirements for the MLCC 114. For example, when the primary electrodes 218 and/or the secondary electrodes 220 are wider in the y-direction, the solder fillet tends to be bigger to create an adequate conductive path between the secondary electrodes 220 and the PCB 108. Alternatively, when the primary electrodes 218 and/or the secondary electrodes 220 are narrow in the y-direction, smaller solder fillet is expected for creating the conductive path between the primary conductive pads 104, secondary conductive pads 106, and the PCB 108. Moreover, as the number of primary conductive layers 208 and secondary conductive layers 206 decrease for particular embodiments, the length of the primary conductive pads 104 and secondary conductive pads 106 (see FIG. 1) in the z-direction becomes shorter. As a result, the solder fillet used to create a conductive path between the secondary conductive pads 106 and the PCB 108 may be decreased. Therefore, to minimize the solder fillet for creating a conductive path between the MLCC 114 and the PCB 108 with sufficient mechanical integrity, the dimensions of the primary conductive pads 104 and secondary conductive pads 106 can be modified accordingly.

The conductive layers 204 can include any suitable conductive material such as, but not limited to, tin, copper, silver, palladium, gold, nickel, etc. or any combination thereof. The dielectric layers 202 can include any suitable dielectric materials such as, but not limited to, glass, ceramics, plastics, films, or any suitable combination thereof. Moreover, the conductive layers 204 and/or the dielectric layers 202 can be coated, doped, sputtered, or otherwise processed.

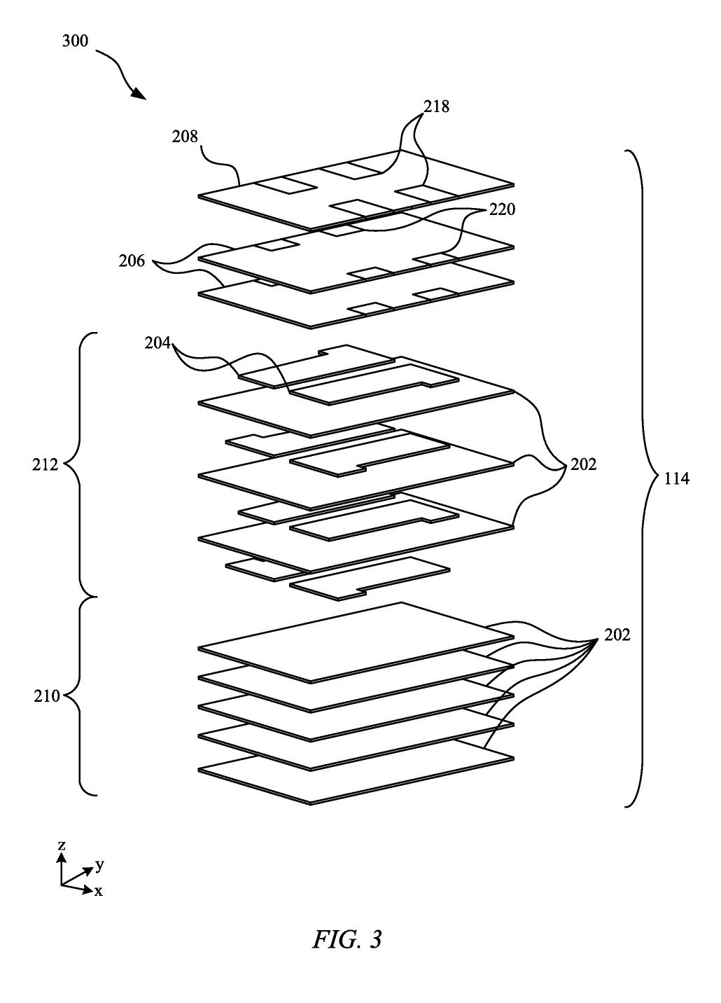

FIG. 3 illustrates an exploded view 300 of some embodiments of the MLCC 114 discussed herein. The elements of FIG. 3 are the same elements from FIG. 2, except the conductive layers 204 have been modified according to some embodiment discussed herein. In particular, FIG. 3 illustrates an embodiment where the conductive layers 204 include a gap extending in the y-direction, which divides each conductive layer into two separate conductive plates. Additionally, tabs on the conductive layers 204 extending in the x-direction alternate orientation for each layer of conductive layer 204. In this way, the configuration of the conductive layers 204 and dielectric layer 202 allows for four voltages to be created at the MLCC 114. By increasing the number of voltages that can be created at one MLCC 114, the deformations of the ceramic material inside a capacitor may cancel out each other, thus showing negligible or small net deformation and further reducing acoustic noise. The conductive layers 204 can incorporate more than a single gap in the y-direction, as further discussed herein. For example, the conductive layers 204 could be split in a diagonal direction with respect to an x-direction and a y-direction, and/or have a plurality of gaps in order to create more voltages at the MLCC 114. Moreover, the MLCC 114 in some embodiments can have any suitable number of conductive layers 204 depending on the number of voltages that may be desired for a particular design.

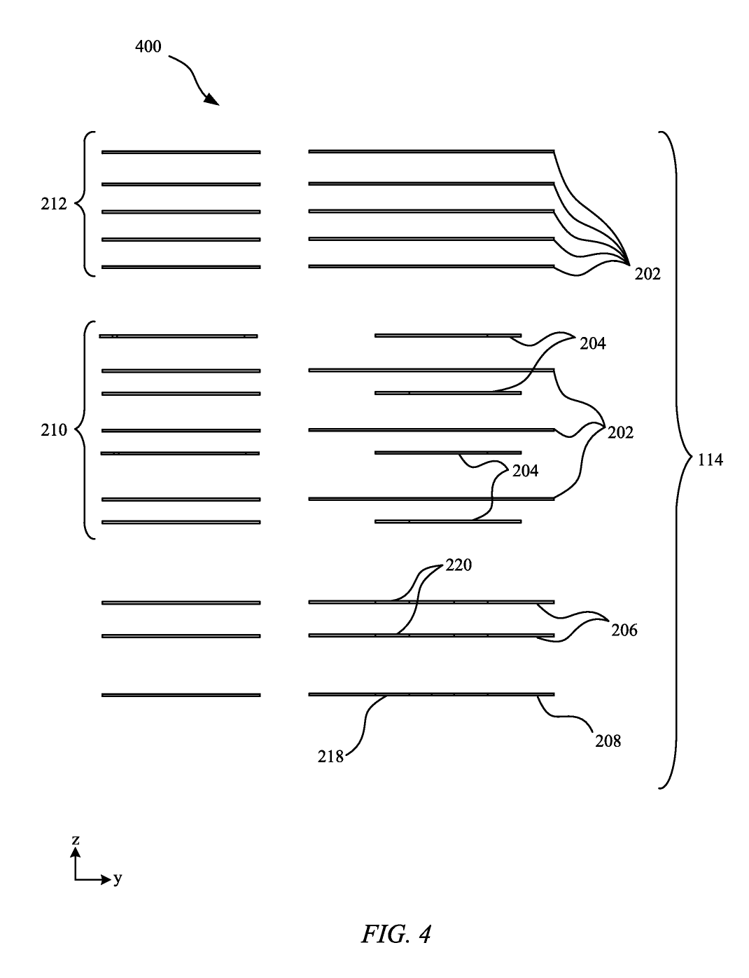

FIG. 4 illustrates a side view 400 of the exploded view 200 of the MLCC of FIG. 2. In particular, FIG. 3 shows how the alignment of the respective components of the MLCC 114 can be modified to create a variety of embodiments for the MLCC 114. All of the dielectric layers 202 are shown as substantially aligned exclusively with other dielectric layers 202 in both an x-direction and a y-direction, while the conductive layers 204 are also aligned exclusively with the conductive layers 204 in an x-direction and a y-direction. The primary electrodes 218 and secondary electrodes 220 are also aligned in a z-direction such that they can contact each other when the MLCC 114 is assembled. This arrangement provides a better interface for solder to connect to the secondary conductive pads 106 of the MLCC 114 to the PCB 108. In some embodiments, the conductive layers 204 are not substantially aligned, but rather are configured to provide a variety of shapes and arrangements for the secondary conductive pads 106. Such departure from substantial alignment can be useful when connecting the MLCC 114 between multiple components or boards that have varying positions and/or electrodes in the z-direction.

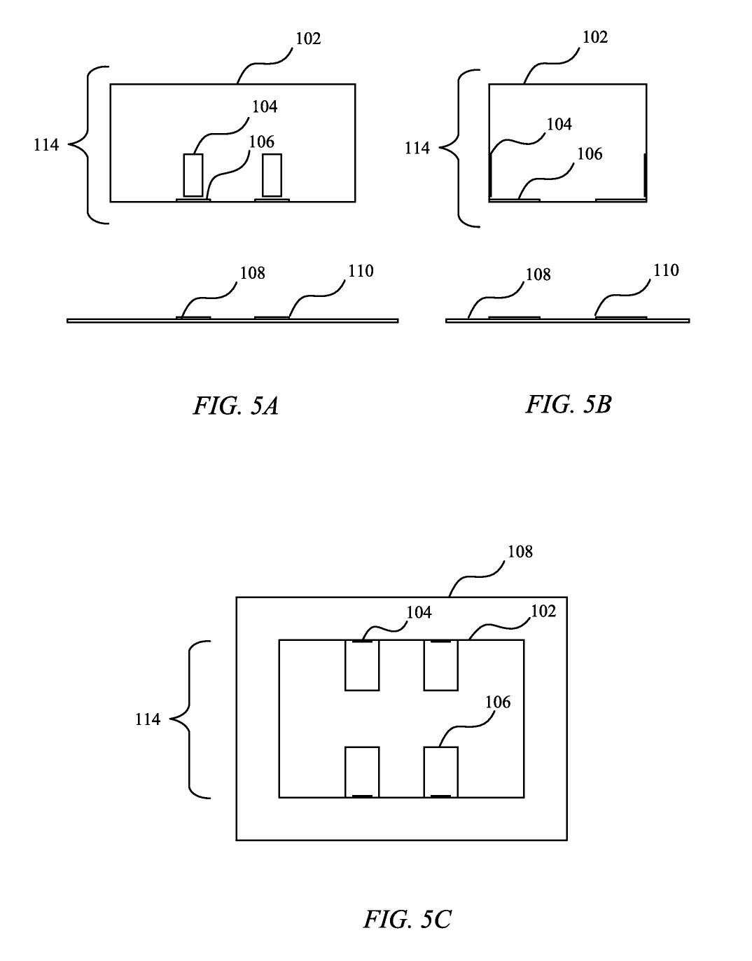

FIG. 5A-5C illustrate various perspective views of the embodiment of the MLCC 114 of FIG. 1. In particular, FIG. 5A illustrates a side view of FIG. 1 from the y-direction and FIG. 5B illustrates a side view of FIG. 1 from the x-direction. Additionally, FIG. 5C illustrates a top view of FIG. 1 from the z-direction. FIG. 5A-5D are provided to illustrate the orientation and alignment of the various components of the MLCC 114. The primary conductive pads 104 and the PCB contacts 110 are shown as being substantially aligned so that they can abut each other when the MLCC 114 is assembled to the PCB 108. However, in some embodiments, the primary conductive pads 104 can be offset from the PCB contacts 110. Additionally, in some embodiments, the primary conductive pads 104 and/or the secondary conductive pads 106 can extend further into the dielectric region 102 or away from the dielectric region 102 by modifying the dimensions of the primary electrodes 218 and secondary electrodes 220, as discussed herein. Additionally, in some embodiments the primary conductive pads can be shorted through an external circuit.

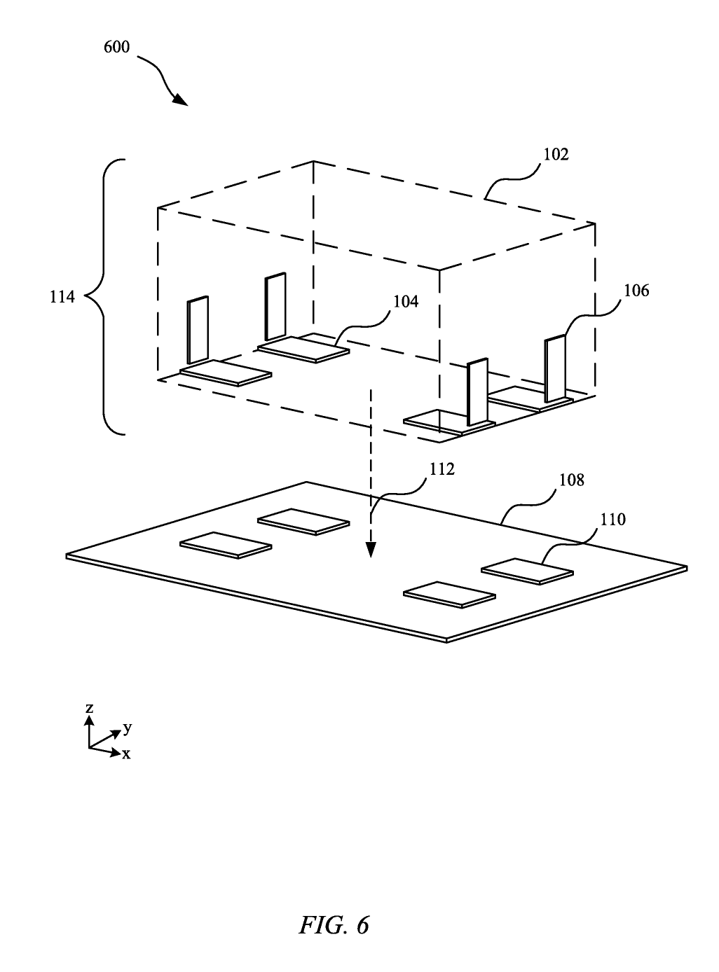

FIG. 6 illustrates a perspective view 600 of the MLCC 114 according to some embodiments set forth herein. In particular, FIG. 6 illustrates an embodiment of the MLCC 114 where the primary conductive pads 104 are formed on a surface of the MLCC 114 parallel to the printed circuit board (PCB) 108 and extend parallel in the x-direction. The secondary conductive pads 106 extend substantially in the z-direction and y-direction, perpendicular to both the PCB 108 and the primary conductive pads 104. The embodiment of the MLCC 114 illustrated in FIG. 6 includes all the components and alternative embodiments of the MLCC 114 of FIG. 1, except that the MLCC 114 of FIG. 6 includes a different arrangement for the various components of the MLCC 114.

It should be noted that the embodiments illustrated in FIG. 1 and FIG. 6 show the MLCC 114 having a greater length in the x-direction than in the y-direction and z-direction. However, in some embodiments the dimensions of the MLCC 114 can vary depending on the application for the MLCC 114. For example, in some embodiments, the MLCC 114 has a length that is longer in the y-direction than in the x-direction. Moreover, the MLCC 114 can have equal lengths in the x-direction, y-direction, and/or z-direction. Further, the MLCC 114 can extend more in the z-direction than the MLCC 114 extends in an x-direction and a y-direction. In some embodiments, the MLCC 114 has curved surfaces in order to provide a smoother profile for the MLCC 114 thereby limiting the number of flat surfaces that can be vibrated by the piezoelectric effect. For example, in some embodiments the secondary conductive pads 106 can be arranged radially outwardly from a center of the MLCC 114. Moreover, the secondary conductive pads 106 can be perpendicular to the PCB 108 as shown in FIG. 6, or configured to extend in a direction less than or greater than 90 degrees with respect to the PCB 108. In this way, vibrations caused by the piezoelectric effect could be directed based on the angle at which the secondary conductive pads 106 extend.

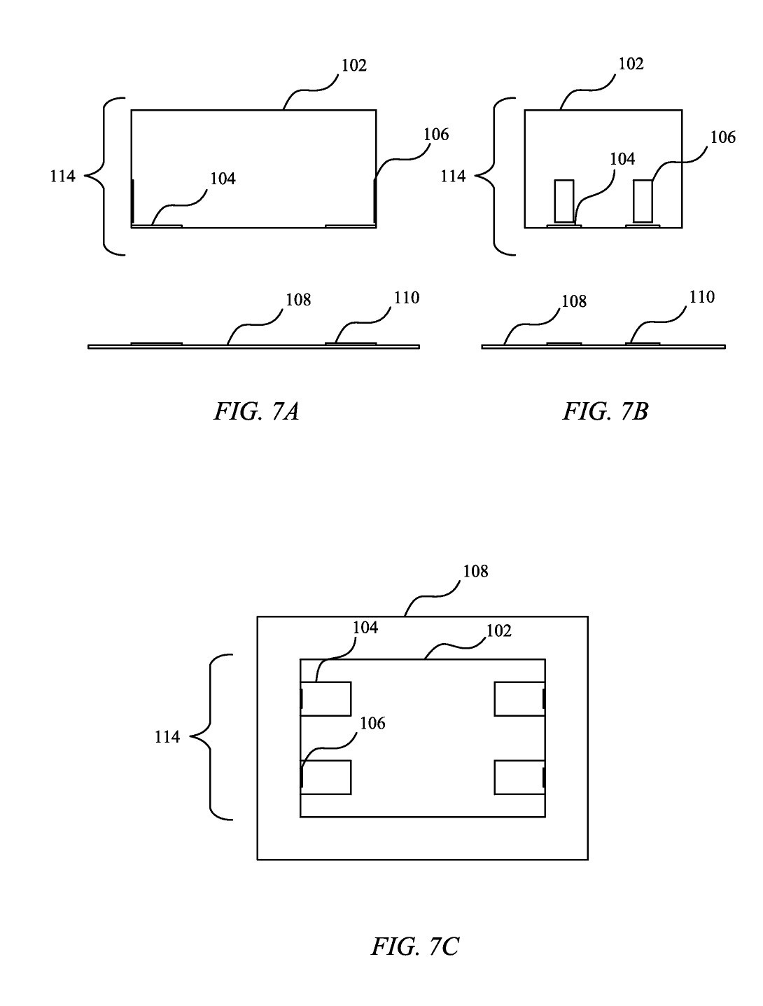

FIG. 7A-7C illustrate various perspective views of the embodiment of the MLCC 114 of FIG. 6. In particular, FIG. 7A illustrates a side view of FIG. 6 from the y-direction and FIG. 7B illustrates a side view of FIG. 6 from the x-direction. Additionally, FIG. 7C illustrates a top view of FIG. 6 from the z-direction. FIG. 7A-7D are provided to illustrate the orientation and alignment of the various components of the MLCC 114. The primary conductive pads 104 and the PCB contacts 110 are shown as being substantially aligned so that they can abut each other when the MLCC 114 is assembled to the PCB 108.

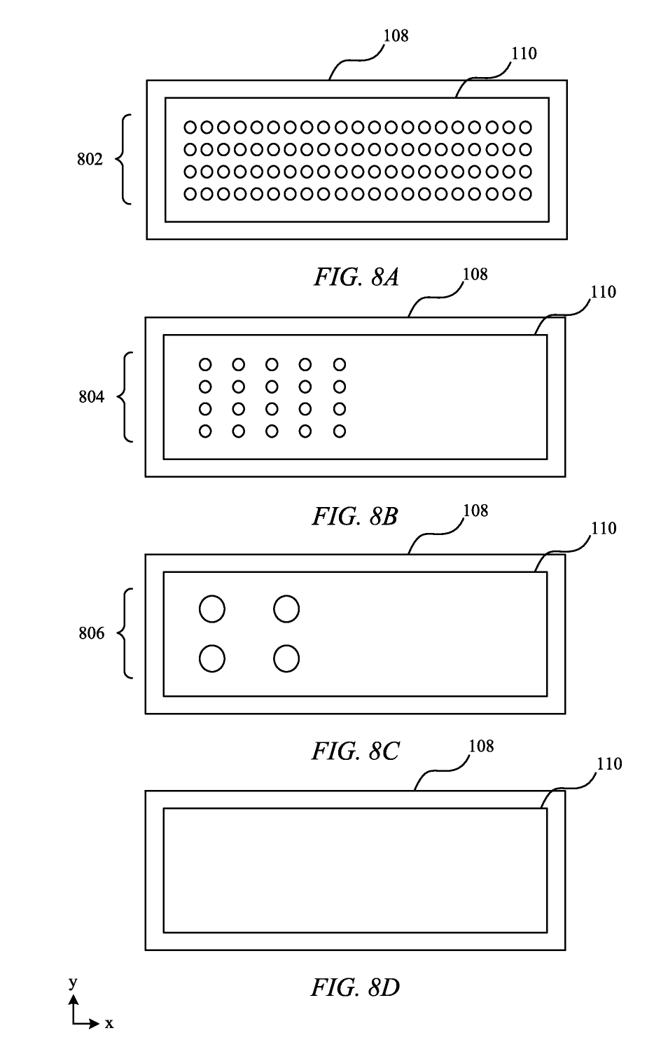

FIGS. 8A-8D illustrate embodiments having different means for attaching the primary conductive pads 104 and the PCB 108. In some embodiments, as shown in FIGS. 8A-8C, arrays of solder are deposited onto the PCB contact 110. In FIG. 8A, an array of solder 802 is arranged to have more density over the surface of the PCB contact 110 as compared to FIGS. 8B-8D. FIG. 8B shows an array of solder 804 that is deposited over only about half of the PCB contact 110. In some embodiments, the array of solder 804 can be configured on the PCB contacts 110 such that each ball or bump of solder is not evenly distributed over the PCB contact 110 with respect to the other balls or bumps of solder. Additionally, the PCB contacts 110 can have points or arrays of solder that are located more proximate to the perimeter of the PCB 108 abutting the PCB contacts 110 in an x-direction and/or a y-direction. Alternatively, the PCB contacts 110 can include points or arrays of solder that are less proximate to the perimeter of the PCB 108 abutting the PCB contact 110. In some embodiments, as shown in FIG. 8C, larger balls or bumps of solder can be deposited in an array of solder 806 on the PCB contact 110. The embodiments of FIGS. 8A-8C can be combined in any suitable manner for a particular design or device. In some embodiments, no solder is used to create a conductive path between the primary conductive pads 104 and the PCB contact 110. In this way, the primary conductive pad 104 can directly abut the PCB contact 110 without any additional layers of material between them. By eliminating the use of solder between the MLCC 114 and the PCB 108, less piezoelectric noise is created by the MLCC 114 when the MLCC 114 is receiving or transmitting alternating current.

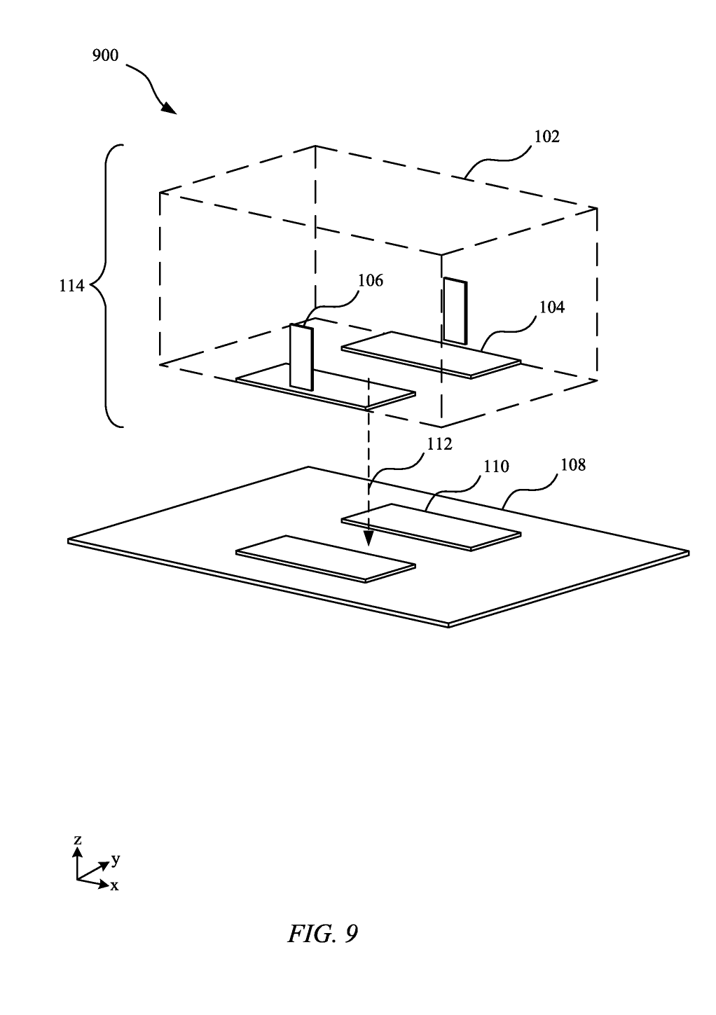

FIG. 9 illustrates a perspective view 900 of an embodiment of the MLCC 114 having, ultimately, two connections to the PCB 108. The primary conductive pads 104 extend in an x-direction and have a length that is greater than the width of the secondary conductive pads 106. The primary conductive pads 104 connect to the PCB contacts 110 when the MLCC 114 is placed on the PCB contacts 110 through the direction 112. In some embodiments, the primary conductive pads 104 substantially span the entire length of the MLCC 114 in the x-direction. Additionally, in some embodiments, the secondary conductive pads 106 can span the entire length of the MLCC 114 in the z-direction. The secondary conductive pads 106, in some embodiments can be configured at angles less than or greater than 90 degrees with respect to the x-direction or the y-direction. This can be accomplished by arranging the secondary electrodes 220, discussed with respect to FIG. 2, such that each secondary conductive layer 206 includes a secondary electrode 220 that is incrementally offset from the z-direction in an x-direction and/or a y-direction.

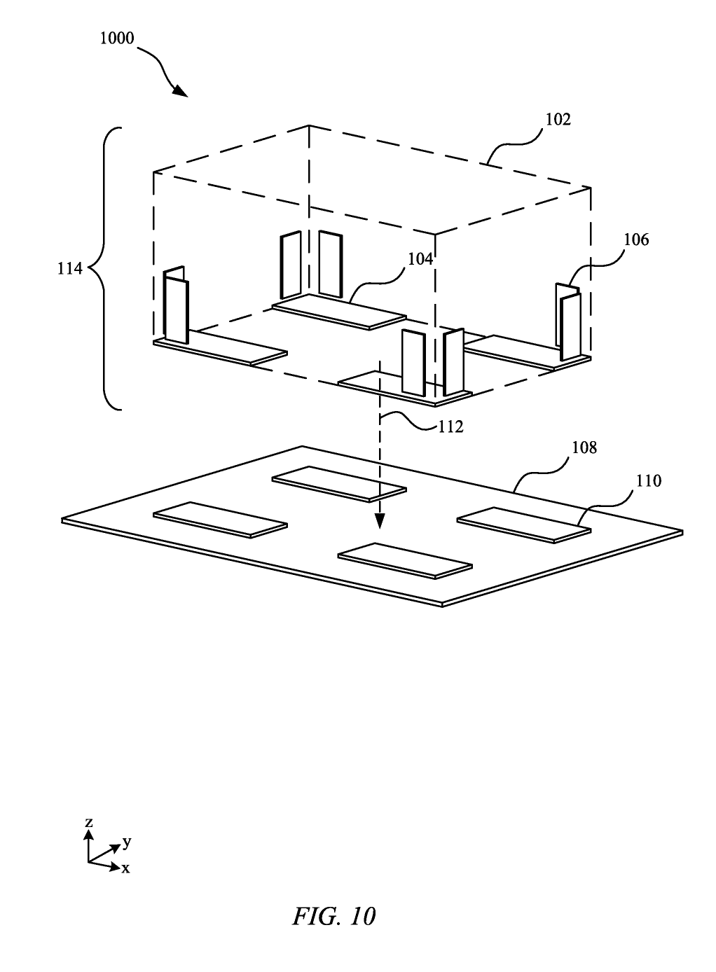

FIG. 10 illustrates a perspective view 1000 of an embodiment of the MLCC 114 having eight secondary conductive pads 106. The secondary conductive pads 106 extend in the z-direction and are arranged on four sides of the MLCC 114 facing an x-direction and a y-direction, including two secondary conductive pads 106 on each of the four sides. The secondary conductive pads 106 are arranged more proximate to the corners of the MLCC 114, and reside directly above the primary conductive pads 104 in the z-direction. The MLCC 114 will be combined with the PCB 108 in a direction 112 so that the primary conductive pads 104 and the PCB contacts 110 are placed into contact with each other. Solder fillets can be deposited to the corners of the MLCC 114 when the MLCC 114 and the PCB 108 are combined. By configuring multiple secondary conductive pads 106 at the corners of the MLCC 114, the solder fillets can better grip the MLCC 114 against the PCB 108 as opposed to only having one or two secondary conductive pads 106 in the middle of one or two sides of the MLCC 114. The embodiment set forth in FIG. 10 can be arranged or modified in any suitable manner discussed herein. For example, the dimensions of the dielectric region 102 can be modified to have a greater or shorter length in the z-direction. Additionally, more or less primary conductive pads 104 and/or secondary conductive pads 106 can be incorporated in some embodiments.

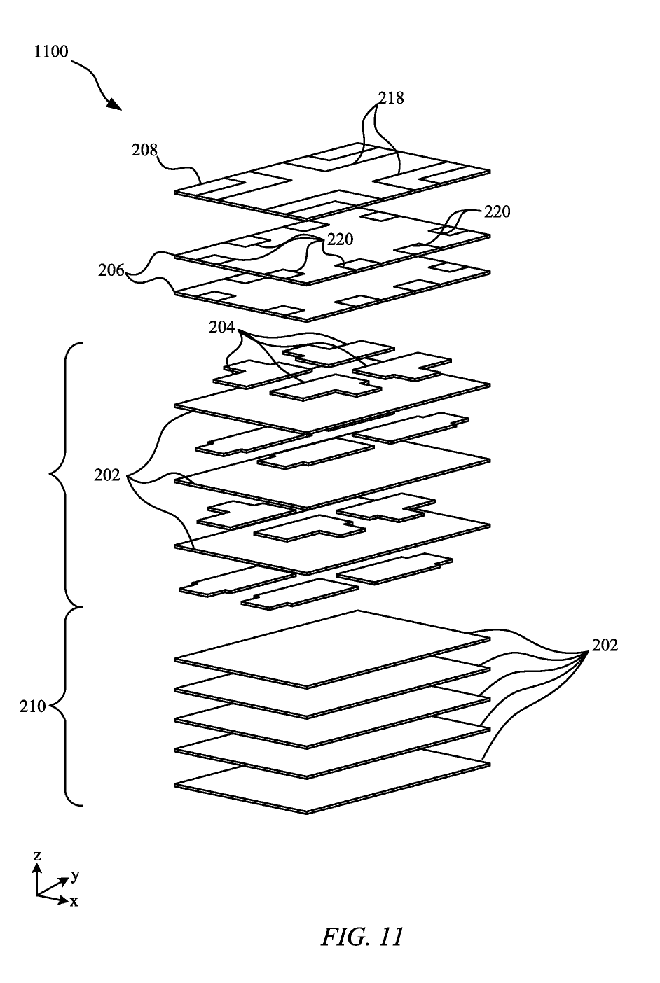

FIG. 11 illustrates an exploded view 1100 of the MLCC 114 of FIG. 10. Specifically, FIG. 11 sets forth the arrangement of the various layers of the MLCC 114 for a build process of the MLCC 114 according to some embodiments. Similar to FIG. 2, the dielectric layers 202 are stacked to create a base 210 for the MLCC 114. The base 210 can be the top of the MLCC 114 once the MLCC 114 is attached to the PCB 108. An active region 212 is made up of dielectric layers 202 and conductive layers 204. This configuration in part provides the charge storing capabilities of the MLCC 114, and also determines the location and dimensions of the secondary conductive pads of FIG. 10. In some embodiment of FIG. 11, the conductive layers 204 are split into four individual conductive layers in order to provide different connections and voltages for the MLCC 114. The conductive layers 204 are internal to the MLCC 114 and include tabs that project from conductive layers 204 in an x-direction and a y-direction such that the tabs can ultimately be connected to the secondary conductive pads 106, of FIG. 10, after assembly of the MLCC 114. The orientation of the tabs provides connections for multiple voltages at the MLCC 114. For example, FIG. 11 illustrates conductive layers 204 having tabs that alternate orientation for each layer of the conductive layers 204. In this way, the tabs that overlap will share voltages and connect to the same primary electrodes 218 and secondary electrodes 220. The tabs of FIG. 11 extend in both an x-direction and a y-direction in order to abut the secondary electrodes 220 that also extend in both an x-direction and a y-direction. In some embodiments, the tabs can be arranged such that more than two tabs extend in an x-direction and/or a y-direction. Additionally, in some embodiments, the tabs can extend in the z-direction either adjacent to, or protruding through, the dielectric layers 202.

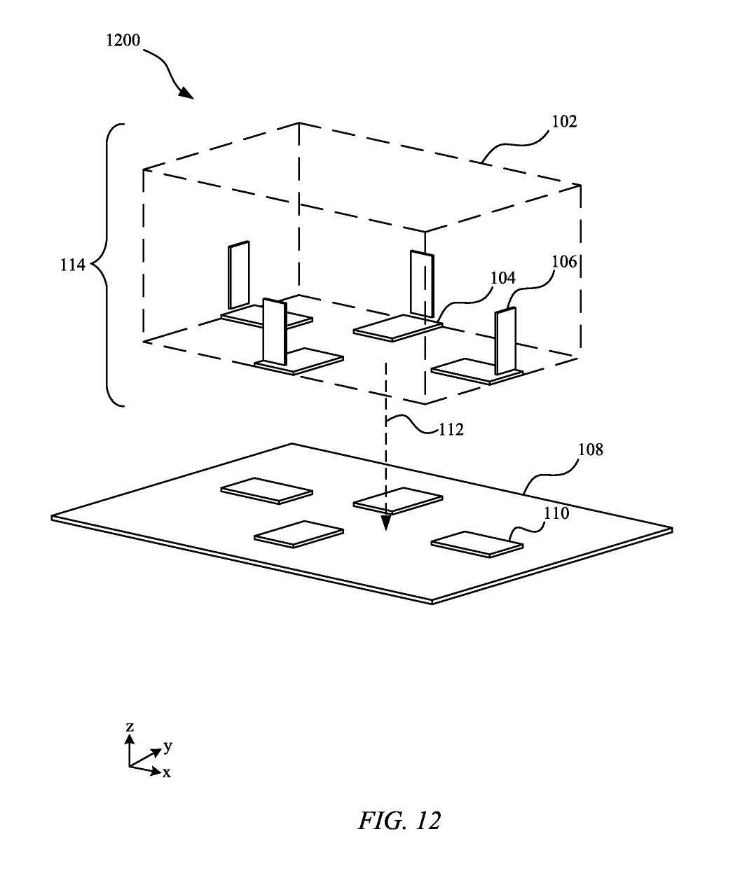

FIG. 12 illustrates a perspective view 1200 of the MLCC 114 according to an embodiment discussed herein. Specifically, FIG. 12 illustrates an embodiment wherein the primary conductive pads 104 are centered on each of the lateral sides of the MLCC 114 in an x-direction and a y-direction. Additionally, the PCB contacts 110 on the PCB 108 are similarly arranged in order to abut the primary conductive pads 104 when the MLCC 114 is applied to the PCB 108 in the z-direction. The embodiment of FIG. 12 can be modified and arranged in accordance with the other embodiments discussed herein. For example, the dielectric region 102 can include one or more dielectric layers depending on the application or design for the MLCC 114.

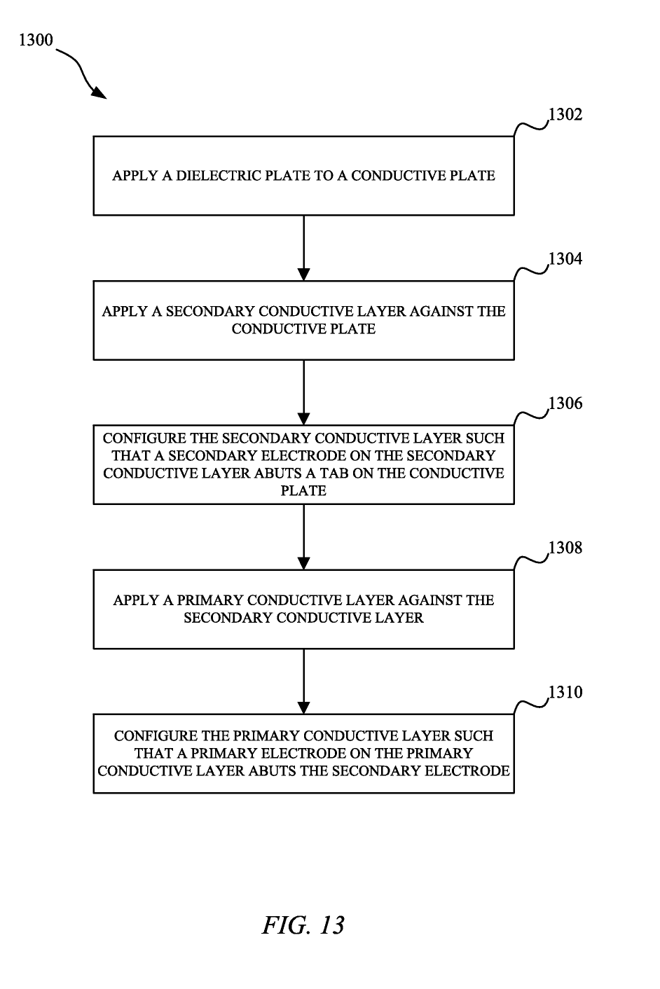

FIG. 13 illustrates a method 1300 of creating the MLCC 114 according to some embodiments discussed herein. The method 1300 includes a step 1302 of applying a dielectric plate to a conductive plate. Next, the method 1300 includes a step 1304 of applying a secondary conductive layer against the conductive plate. The method 1300 also includes a step 1306 of configuring the secondary conductive layer such that a secondary electrode on the secondary conductive layer abuts a tab on the conductive plate. Further, the method 1300 includes a step 1308 of applying a primary conductive layer against the secondary conductive layer. Additionally, the method 1300 includes a step 1310 of configuring the primary conductive layer such that a primary electrode on the primary conductive layer abuts the secondary electrode. The method 1300 can be modified in any suitable manner according to any of the embodiments discussed herein, alone or in combination. Moreover, the order of method 1300 can be modified in any suitable manner.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An apparatus, comprising:
an active region comprising a conductive plate and a dielectric layer, wherein the conductive plate includes a tab that extends from an adjacent portion of the conductive plate and abuts the dielectric layer; and
a primary conductive layer including a primary electrode that contacts the tab.

2. The apparatus of claim 1, comprising:
a secondary conductive layer including a secondary electrode that contacts the tab of the conductive plate and is exposed at a lateral surface of the apparatus.

3. The apparatus of claim 1, wherein the active region comprises a first conductive plate having a first tab and a second conductive plate having a second tab; and
the first tab and the second tab are offset from each other in a z-direction and occupy different regions defined by an x-direction and a y-direction.

4. The apparatus of claim 1, wherein the primary conductive layer includes multiple primary electrodes configured parallel or perpendicular to each other in an x-direction and/or a y-direction.

5. The apparatus of claim 1, further comprising a conductive pathway between the primary electrode and the tab of the conductive plate.

6. The apparatus of claim 1, wherein the primary conductive layer includes multiple primary electrodes that are substantially parallel to the conductive plate.

7. The apparatus of claim 1, wherein the active region includes multiple conductive plates that are parallel to the primary electrode.

8. The apparatus of claim 1, wherein the active region includes a first conductive plate and a second conductive plate that are separated by a gap, and reside on the same surface.

9. A capacitor, comprising:
an active region including a conductive plate and a dielectric plate, wherein the conductive plate includes a tab that extends outward from an adjacent portion of the conductive plate;
a secondary conductive layer that includes a secondary electrode that abuts the tab; and
a primary conductive layer that includes a primary electrode that abuts the secondary electrode.

10. The capacitor of claim 9, wherein the capacitor further comprises:
two lateral surfaces, wherein the secondary conductive layer includes a plurality of secondary electrodes that form a stack that extends in a z-direction that is substantially parallel to the primary electrode, and the stack is exposed at the two lateral surfaces.

11. The capacitor of claim 10, wherein the plurality of secondary electrodes form a first stack and a second stack that extend in the z-direction, and the first stack is at least partially exposed at a first lateral surface and the second stack is at least partially exposed at a second lateral surface.

12. The capacitor of claim 10, wherein the plurality of secondary electrodes form a first stack and a second stack that extend in the z-direction, and the first stack and second stack are at least partially exposed on the same lateral surface.

13. The capacitor of claim 10, wherein the plurality of secondary electrodes form at least four stacks that extend in the z-direction, and are configured such that:
at least two stacks of the at least four stacks are at least partially exposed on a first lateral surface of the capacitor, and
at least two stacks of the at least four stacks are at least partially exposed on a second lateral surface of the capacitor.

14. The capacitor of claim 9, the capacitor further comprising:
at least four lateral surfaces, wherein:
the plurality of secondary electrodes form a plurality of stacks that extend in a z-direction, and
each stack of the plurality of stacks is at least partially exposed at a lateral surface of the at least four lateral surfaces.

15. The capacitor of claim 9, wherein the active region includes multiple conductive plates that are:
separated by a gap in an x-direction and/or a y-direction, and
configured between the second dielectric plate and the secondary conductive layer.

16. A method for constructing an electrical component, comprising:
placing a dielectric plate against a first conductive plate, wherein the first conductive plate includes a first tab extending from an adjacent portion of the first conductive plate and abuts the dielectric plate;
placing a secondary conductive layer against the first conductive plate, wherein the secondary conductive layer includes a secondary electrode that is configured to contact the first tab of the first conductive plate; and
placing a primary conductive layer against the secondary conductive layer, wherein the primary conductive layer includes a primary electrode that is configured to contact the secondary electrode.

17. The method of claim 16, further comprising:
placing a second conductive plate against the dielectric plate, wherein the second conductive plate includes a second tab that:
extends from an adjacent portion of the second conductive plate,
occupies a different area than the first tab, wherein the area is defined by an x-direction and a y-direction, and
does not overlap the first tab in a z-direction.

18. The method of claim 17, wherein the first tab and the second tab are exposed at a lateral surface of the electrical component.

19. The method of claim 16, further comprising:
placing multiple secondary electrodes in a stack that extends in a z-direction, and is perpendicular to the primary conductive layer.

20. The method of claim 16, further comprising:
placing a second conductive plate adjacent to the first conductive plate in an x-direction and/or y-direction, wherein the first conductive plate and the second conductive plate are separated by a gap, and the first conductive plate and the second conductive plate about the same surface of the dielectric plate.
